(19) United States
(12) Patent Application Publication
(10) Pub. No.: US 2026/0194468 A1
(43) Pub. Date: Jul. 9, 2026

(54) Method for determining at least one parameter of a laser device, especially a laser plotter, using LIBS (Laser Induced Breakdown Spectroscopy) for processing a workpiece, as well as a laser device for this purpose

(71) Applicant: Trotec Laser GmbH, Marchtrenk (AT)

(72) Inventor: Hagen STRASSER, Pasching (AT)

(21) Appl. No.: 19/131,837

(22) PCT Filed: Oct. 19, 2023
(86) PCT No.: PCT/EP2023/079078

§ 371 Date: May 21, 2025

(30) Foreign Application Priority Data
Nov. 24, 2022 (AT) A50889/2022

(51) Int. Cl. G01N 21/71; B23K 26/352; G01N 1/34

(52) U.S. Cl. CPC G01N 21/718; B23K 26/352; G01N 1/34

(57) ABSTRACT

A laser device and a method for determining at least one parameter of a laser device using LIBS (Laser Induced Breakdown Spectroscopy) for processing a workpiece are disclosed. In a housing of the laser device, a radiation source in the form of a laser is used. When the radiation source is activated, a laser beam is directed via deflection elements to a focusing unit or laser head. To determine the parameter “material”, a LIBS process is started by the laser device or an external component connected to the laser device. The workpiece is processed in a known manner with the laser such that a small amount of material from the workpiece is vaporized. The vaporized material is detected and evaluated by a spectrometer. The determined material is displayed to the user on the laser device or the external component and/or the determined material is set as the parameter “material”.

### TECHNICAL FIELD

The present disclosure relates to a method for determining at least one parameter of a laser device, especially a laser plotter, using LIBS (Laser Induced Breakdown Spectroscopy) for processing a workpiece, as well as a laser device.

### DESCRIPTION OF THE RELATED ART

Various applications of LIBS (Laser Induced Breakdown Spectroscopy) are known from the prior art. For example, a sorting device is equipped with a LIBS laser device, according to EP 3967413 A1.

The laser-induced plasma spectroscopy method, also known as LIBS, is a fast and non-contact technique for analyzing solid, liquid, or gaseous substances, as disclosed in Wikipedia 4. In this process, a small volume of the material, especially the workpiece, is vaporized and ionized into a plasma by bombardment with short laser pulses. When the plasma decays, light is emitted that is characteristic of the elements contained. The spectrum of the radiation is recorded with a spectrometer, allowing the element-specific composition of the material to be determined.

### SUMMARY OF EMBODIMENTS

The object of the present disclosure is to provide a method for determining at least one parameter of a laser device, especially a laser plotter, using LIBS (Laser Induced Breakdown Spectroscopy) for processing a workpiece and a laser plotter for this purpose, which avoids the aforementioned disadvantages and achieves high user-friendliness and safety in processing a workpiece on the laser device.

The object is solved by the disclosed embodiments. Advantageous embodiments and/or procedural measures are described in the subclaims.

The object of the present disclosure is solved by a method for determining a parameter of a laser device, especially a laser plotter, using LIBS (Laser Induced Breakdown Spectroscopy) for processing a workpiece, in which the parameter “material” for setting the laser device is determined by a LIBS process (Laser Induced Breakdown Spectroscopy), especially a material recognition process, manually or automatically started by the laser device or an external component connected to the laser device, especially a laptop. The workpiece is processed, especially irradiated, with a laser, especially laser radiation, in such a way that a small amount of material from the workpiece is vaporized. The vaporized material, especially a plasma, is detected and evaluated by a spectrometer. The determined material is displayed to the user on the laser device or the external component, especially a laptop, and/or the determined material is set as the parameter “material” or compared with the set material of the parameter “material”.

An advantage is that the process safety is significantly increased by the use of material recognition through a so-called LIBS process (Laser Induced Breakdown Spectroscopy), which has been known for many years, as the inserted material is automatically recognized, so that, for example, a message or processing stop is issued for unsuitable materials. It is also possible to compare the set parameters, especially laser power, material thickness, etc., with the determined material, so that a warning is issued for unsuitable settings, such as too high laser power. Furthermore, a simple setting or adoption of the inserted material is achieved by merely starting the LIBS process on the laser device or the external component. Thus, the user only needs to adopt the recognized and displayed material. Another significant advantage is that the used materials can be automatically documented, allowing quick and easy tracking in case of damage or repairs to determine if the laser device was used as intended.

Measures are advantageous in which, after starting the LIBS process, a cleaning irradiation of the surface of the workpiece or material is first carried out before the actual LIBS process for generating and recording the plasma for evaluating the material or the parameter “material” is executed. This ensures that impurities are removed before the actual LIBS process, allowing safe material recognition to be carried out. Preferably, the cleaning irradiation is optionally activated in the software, especially in the operator software. It is also possible to perform several cleaning cycles consecutively. Preferably, the consecutive cleaning irradiations are manually activated, or the user can enter or select the number of cleaning cycles to be performed.

Measures are advantageous in which the determined material is compared with stored materials, and for unsuitable materials, such as leather and synthetic leather with chromium (VI), carbon fibers (carbon), polyvinyl chloride (PVC), polyvinyl butyral (PVB), polytetrafluoroethylene (PTFE/Teflon), beryllium oxide, etc., an error message or indication appears on the laser device and/or the external component. This ensures that damage to the device is avoided and the formation of dangerous substances or gases for the user is prevented. Furthermore, documentation of the used materials can be recorded for warranty claims against the manufacturer to document improper use.

Measures are advantageous in which a separate area, especially a material recognition area, in which the spectrometer is positioned, is approached in the processing room, especially on the processing table, to execute the LIBS process. Preferably, the workpiece is first placed in this area, and after starting the LIBS process, the laser head is moved to a defined position to execute the LIBS process. The irradiation of the workpiece is carried out by the laser head, and the recording of the generated plasma is carried out by the spectrometer positioned in the area. This ensures that the laser head or focusing unit can be kept very compact, as the spectrometer is fixedly mounted in the material recognition area. Thus, there are no losses in the processing speed of the laser head or focusing unit, as the laser head or focusing unit does not have to transport additional mass and the size does not change. It is also possible that after starting the LIBS process, the laser head or focusing unit is moved to the material recognition area, and a query “insert material” appears on the laser device or external component, allowing material to be placed in or under the material recognition area. After confirming the query, the LIBS process is executed. Furthermore, the material recognition area can be designed so that after moving the laser head or focusing unit, a cover or closure of the opening to the processing room can be carried out to further reduce light entry into the otherwise darkened material recognition area and thus advantageously influence the accuracy of the LIBS process.

Measures are advantageous in which the laser beam is decoupled from the beam path for the laser head when the LIBS process is activated. This ensures that the LIBS process, especially the material recognition process, can be carried out independently of the laser head or focusing unit, i.e., that in the material recognition area, in addition to the spectrometer, elements, especially a lens, for laser processing of the inserted material or workpiece are arranged. Thus, the laser head or focusing unit no longer needs to be moved to the material recognition area.

Measures are advantageous in which the decoupled laser beam is guided in a separate material recognition area, especially in a LIBS area, inside or outside the processing room. This ensures that for recognizing an inserted material, it is placed in a separate area, allowing the LIBS process to be carried out. The material recognition area is significantly smaller than the processing room, so for larger workpieces, only a part protrudes into the material recognition area or is placed, and the rest of the workpiece is either held or placed on a shelf. It is advantageous if the material recognition area is equipped with sensors to detect whether material is inserted, allowing an automatic start of the LIBS process when material or workpiece is inserted.

Measures are advantageous in which the decoupled laser beam is redirected in a material recognition area in the processing room. This ensures that the entire workpiece can be inserted in the processing room, especially in the material recognition area, independently of the laser head or focusing unit, and the LIBS process can be carried out without moving the laser head.

Measures are advantageous in which at least one spectrometer for recording the emitted radiation of a plasma during the LIBS process and preferably a lens or lens unit for focusing the laser beam are arranged and used in the processing room and/or outside the processing room. This ensures that the laser head or focusing unit is equipped with as few additional components as possible, allowing the laser head or focusing unit to be moved very agilely.

Measures are advantageous in which the material recognition area outside the processing room is formed by a slot in the housing and/or a cover or lid on the housing. This ensures that the material recognition area is optimally equipped for the LIBS process, i.e., that a special lens for generating the plasma on the workpiece can be used and that the spectrometer is optimally positioned for recognizing or recording the plasma.

Measures are advantageous in which the LIBS process for determining the material accesses an external and/or internal database or cloud, especially a material library. This ensures the highest possible recognition quality of the used materials.

Measures are advantageous in which the data of the LIBS process are collected for analysis, diagnosis, and/or documentation, especially of misapplications. This ensures that in case of errors, warranty claims can be easily checked.

Measures are advantageous in which a separate laser source or laser is activated for the LIBS process, and its laser beam is coupled into the beam path for the laser head or the material recognition area. This ensures safe recognition of the material, as an optimal laser for generating the laser pulses is used.

The object of the present disclosure is also solved by a laser plotter for cutting, engraving, marking, and/or labeling a workpiece, in which the focusing unit or laser head is equipped with a spectrometer for detecting a plasma generated by irradiation during a LIBS process.

An advantage is that the LIBS process can be carried out regardless of the inserted position of the workpiece. First, the workpiece is placed in any position on the processing table, and then the laser head is preferably positioned on the workpiece with the activated laser pointer, and the LIBS process is preferably started manually.

Furthermore, the object of the present disclosure is also solved by a laser device in the form of a laser plotter or galvo laser for cutting, engraving, marking, and/or labeling a workpiece, in which the laser beam is decoupled from the usual beam path for executing a LIBS process and redirected into a material recognition area arranged inside or outside the processing room.

An advantage is that the laser head or focusing unit does not need to be moved for material recognition of the workpiece, but a corresponding lens and spectrometer for the LIBS process are arranged in the material recognition area.

An advantage is the design in which at least one spectrometer for recording a plasma during the LIBS process is arranged in the material recognition area. This ensures that the laser head or focusing unit can be moved very agilely, as no additional components that make the laser head or focusing unit sluggish are attached.

The disclosure is subsequently described in the form of exemplary embodiments, noting that the disclosed embodiments are not limited to the illustrated and described exemplary embodiments or solutions but can be transferred to equivalent solutions.

### BRIEF DESCRIPTION OF THE DRAWINGS

Figures show:

FIG. 1: a schematic representation of a laser machine, especially a laser plotter, for processing a workpiece and executing a LIBS process, in simplified, schematic representation;

FIG. 2a: a schematic representation of the laser head with an attached spectrometer for a LIBS process with activated laser to generate a plasma from the material of the workpiece, in simplified, schematic representation;

FIG. 2b: a schematic representation of the laser head with an attached spectrometer for a LIBS process with deactivated laser and activated spectrometer to record the plasma from the material of the workpiece according to FIG. 2a, in simplified, schematic representation;

FIG. 3: a top view of the laser device with a schematically drawn material recognition area with spectrometer, in simplified, schematic representation;

FIG. 3a: another top view of the laser device with a different placement of the material recognition area, in simplified, schematic representation;

FIG. 4: a top view of the laser device with its own material recognition area in the processing room where the laser beam is decoupled, in simplified, schematic representation;

FIG. 5: a top view of the laser device with its own material recognition area arranged outside the processing room in the form of a flap or slot for inserting the workpiece for a LIBS process, in simplified, schematic representation;

FIG. 6: a schematic representation of a galvo laser with a material recognition area for a LIBS process, in simplified, schematic representation.

It should be noted that in the different embodiments, identical parts are provided with identical reference signs or identical component designations, and the disclosures contained in the entire description can be transferred to identical parts with identical reference signs or identical component designations. The positional indications chosen in the description, such as top, bottom, side, etc., refer to the described figure and should be transferred to the new position in case of a positional change.

### DETAILED DESCRIPTION OF EMBODIMENTS

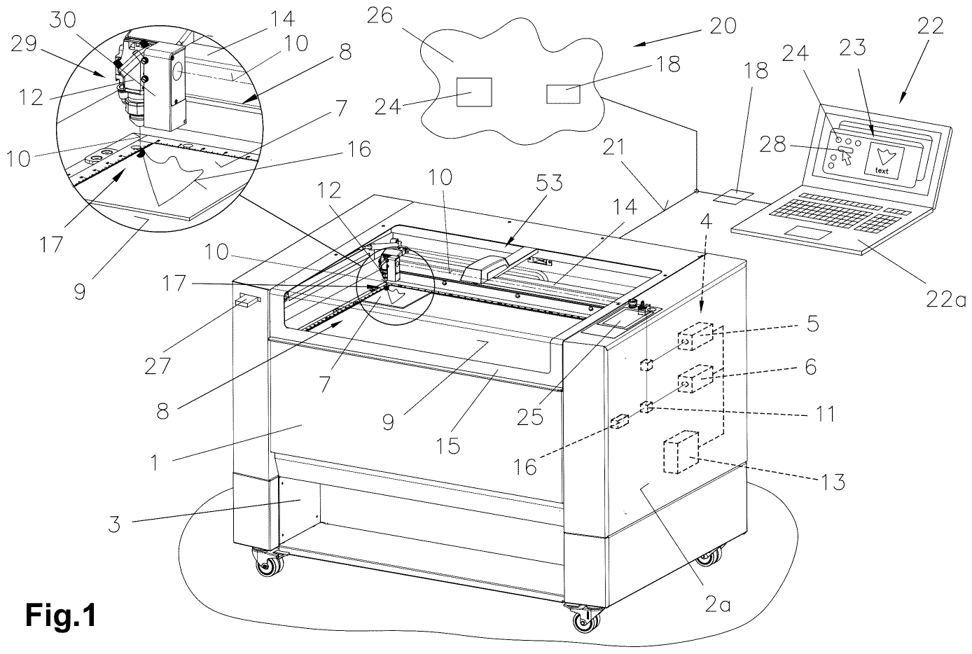

FIGS. 1 to 6 show exemplary embodiments for laser machines or laser devices 1, especially a laser plotter 2a and galvo laser 2b. An application with a flatbed laser is also possible.

In the shown laser plotter 2a, according to FIG. 1, at least one, preferably two, radiation sources 4 or laser sources 4 in the form of lasers 5, 6 are arranged in a housing 3. The lasers 5 and 6 preferably act alternately on a workpiece 7 to be processed. The workpiece 7 is or will be positioned in a processing room 8 of the laser plotter 2a, especially on a processing table 9, which is preferably height-adjustable. A laser beam 10 emitted by a radiation source 4, especially the laser 5 or 6, is sent via deflection elements 11 to at least one movable focusing unit 12 or laser head 12, from which the laser beam 10 is deflected towards the workpiece 7 and focused for processing. The control, especially the position control of the laser beam 10 to the workpiece 7, is carried out via software running in a control unit 13, whereby the workpiece 7 is processed by adjusting a carriage 14, on which the focusing unit 12 or laser head 12 is preferably arranged to move, preferably via a belt drive in the X-Y direction. It is possible that, for example, in the engraving process, the carriage 14 is adjusted line by line, whereas in the cutting process, the carriage 14 is moved according to the contour to be cut, i.e., not line by line.

In such laser devices 1, especially laser plotters 2a, it is necessary for safety that a lid 15 or door, which is preferably at least partially transparent, must be closed to start processing the workpiece 7, as shown in FIG. 1. Subsequently, the operator can manually or automatically position the laser pointer or a light source 16, for example in the form of a laser pointer 16, especially light beam 17 or laser pointer point 17, which is preferably coupled into the beam path of the laser 5, 6 and deflected towards the processing table 8 via the focusing unit 12 or laser head 12, on the inserted workpiece 7, whereupon a job 18 for processing the workpiece 7 can be started. At the end of the job 18, the carriage 14 and the focusing unit 12 or laser head 12 are preferably moved to the starting position, allowing the finished workpiece 7 to be removed, and a new processing process can be started by inserting a new workpiece 7 or blank 7. It is advantageous if the end of the processing is indicated visually or acoustically, so the user does not have to constantly monitor the laser machine, especially the laser plotter 1. For completeness, it is mentioned that the adjustment of the focusing unit 12 or laser head 12 with activated light beam 17 is also possible with the lid 15 open, but the laser 5, 6 cannot be activated.

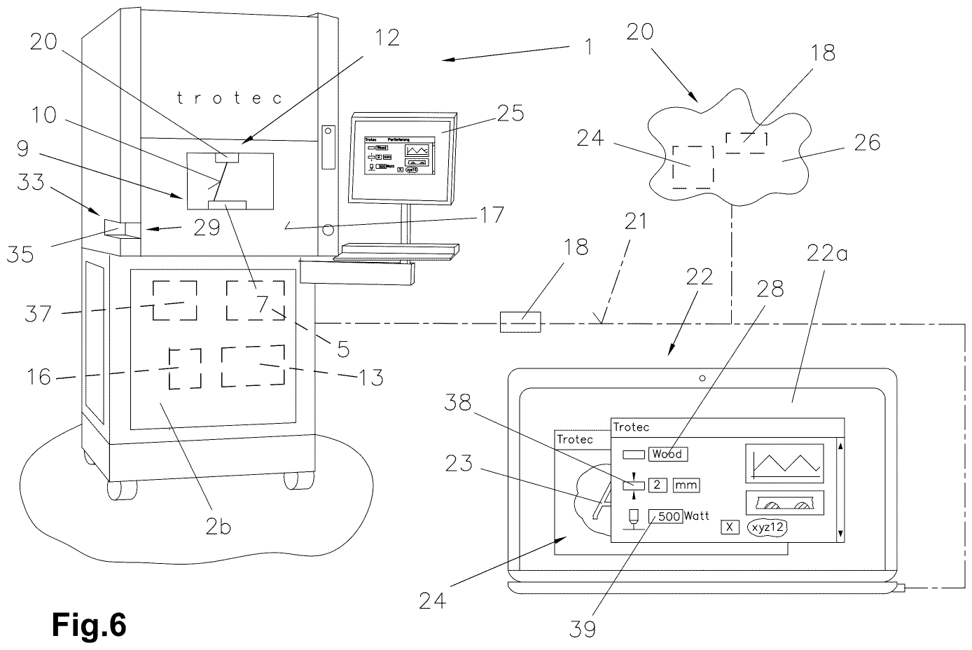

Also known are so-called galvo lasers 2b or galvo marking lasers 2b, as shown in FIG. 6, in which the laser beam 10 of a laser 5 is deflected and positioned towards the workpiece 7 positioned on the processing table 9 via an adjustable mirror 19 in the laser head 12 or focusing unit 12. A light beam 17 (not shown) of a light source 16, especially a laser pointer 16, can also be coupled into the beam path of the laser 5 or arranged on the laser head 12. A control unit 13 is again provided for controlling and regulating the individual elements. It is also possible that the laser head 12 of a galvo laser 2b can be adjusted to better process larger workpieces 7.

For completeness, it is noted that the laser plotter 2a and the galvo marking laser 2b can be equipped with connections or cables for power supply or connection to the intranet and/or internet 20. It is possible that a connection with external components 22, such as a laptop 22a or computer, an automatic feeding unit, a conveyor belt, a removal robot, etc., can be established via a cable 21 or wirelessly via WLAN or Bluetooth, allowing data to be transferred from the external components 22, especially the laptop 22a. For this purpose, a graphic 23 and/or text 23 is created or loaded on the external component 22, especially a computer, laptop 22a, or control device, using commercial software 24, such as CorelDraw, Paint, etc., or the proprietary application software 24, especially Ruby 24, which is preferably exported or transferred to the control unit 13 of the laser device 1 in the form of the job 18. Preferably, the data to be transferred is converted by the same or another software, allowing the control unit 13 to process the job 18. It is also possible that the input can be made directly on the laser plotter 2a or galvo laser 2b using the existing input means 25, such as a touchscreen or input buttons, or a corresponding job 18 can be loaded from a storage medium, such as a cloud 26, a USB stick 27, etc. After the data, especially the jobs 18, have been transferred or created directly or loaded from the storage medium, the job 18 is processed by the laser device 1, especially its control unit 13. It is possible that several jobs 18 can be stored simultaneously in the laser machine 1 and processed sequentially. It is also possible that the application software 24 is installed in the cloud 26 and can be accessed from the cloud 26 via a web browser.

To simplify, support, and/or automate the input of parameters 28, especially the parameter “material” 28, a material recognition process, especially a LIBS process 29 (Laser Induced Breakdown Spectroscopy), is integrated into the laser device 1, especially laser plotter 2a, flatbed laser (not shown), and/or galvo laser 2b.

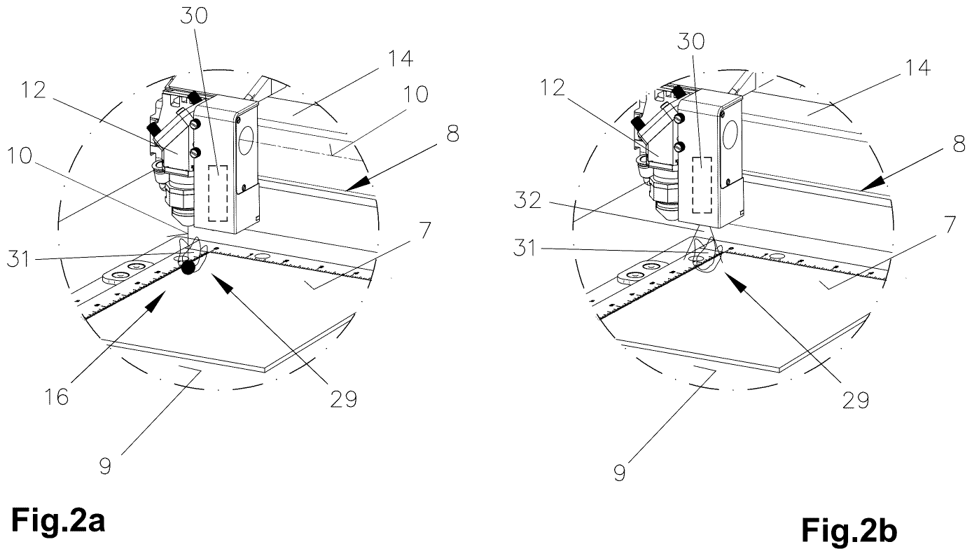

For this purpose, for example, in FIGS. 1, 2a, and 2b, the laser head 12 or the focusing unit 12 is equipped with a spectrometer 30 to detect the plasma 31 generated by the laser beam 10 (FIG. 2a). For this purpose, the laser head 12 or the focusing unit 12 is first preferably positioned on the inserted workpiece 7 using the laser pointer 16, after which the material recognition process, especially the LIBS process 29, is started on the laser device 1, especially on the input means 25, or on the external component 22, especially on the laptop 22a. Subsequently, a radiation source 4, especially a laser 5 or 6, is activated, whereby the laser beam 10 remains activated until a part of the material from the workpiece 7 transitions into a plasma 31, according to FIG. 2a. Subsequently, the laser beam 10 is preferably terminated, and the spectrometer 30, according to FIG. 2b, is activated, so that the plasma 31 is detected by the spectrometer 30. The recorded data is sent to the control unit 13 or the external component 22. The spectrometer 30 or the control unit 13 or the external component 22 then evaluates the recorded light from the plasma 31, especially the transmitted data from the spectrometer 30, so that the material, especially the characteristic optical spectrum, of the inserted workpiece 7 can be determined based on the scattering of the emitted light. After the material has been determined by the spectrometer 30 or by the control unit 13 or the external component 22, it is preferably displayed as the parameter “material” 28 and/or the determined material is set as the parameter 28 or compared with the set parameter 28. Preferably, the determined material is displayed as the set parameter 28, so that the user can decide by pressing an OK/Cancel button whether the newly determined material should be adopted as the parameter 28 or whether the set material should be retained.

In the laser plotter 2a, flatbed laser, and/or galvo laser 2b, a CO2 laser is preferably used for generating pulsed laser radiation 17 for the LIBS process 29, which requires a certain duration for the power build-up of the laser 5, 6. Subsequently, a local plasma 31 is generated on the workpiece 7 by the high energy density of the laser 5, 6 or the laser radiation 17. After the irradiation with the laser 5, 6 is terminated, the plasma 31 cools down again, and the measurement is carried out with the spectrometer 30. By cooling the plasma 31, element-specific light radiation is emitted from the plasma 31, which is recorded and processed by the spectrometer 30. It is also possible that instead of the spectrometer 30 on the laser head 12, one or more light guides are arranged, with which the emitted light radiation of the plasma 31 is recorded and then sent to a spectrometer 30 for further processing.

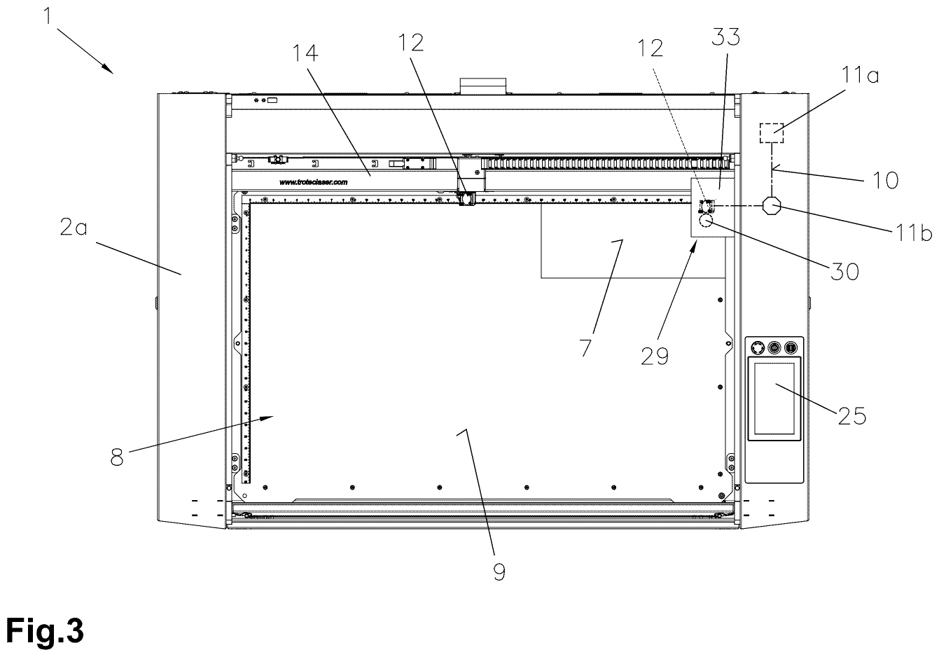

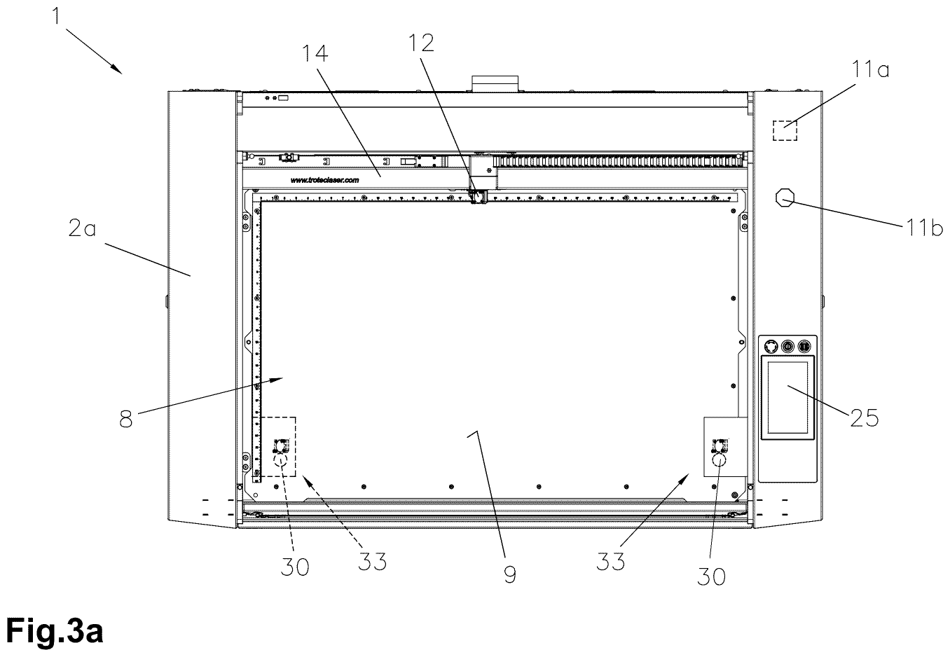

According to FIG. 3, the laser device 1, especially the laser plotter 2a, is shown from above with the lid 15 open or removed to better recognize the processing room 8 or processing table 9. Here, an independent material recognition area 33 is now arranged, in which the spectrometer 30 is positioned, i.e., the spectrometer 30 is no longer arranged or mounted on the laser head 12 or the focusing unit 12, but the spectrometer 30 is arranged or mounted in its own or separate area, namely the material recognition area 33.

To now perform a LIBS process 29, i.e., a material recognition process, it is necessary to place or position the workpiece 7 or a part or sample of the workpiece 7 below the material recognition area 33, so that the LIBS process 29 can be started. After starting the LIBS process 29 on the laser device 1 or the external component 22, the laser head 12 or the focusing unit 12 is moved from any position (shown in solid lines) to a defined position in the material recognition area 33 (shown in dashed lines). An optimal position of the laser head 12 to the spectrometer 30 is provided, so that subsequently the laser 5 or 6 is activated and thus generates a plasma 31 of the material from the workpiece 7. After the laser radiation is terminated, the spectrometer 30 is preferably activated and can record and process the emitted light rays of the plasma 31. To supply the laser head 12 with the laser beam 10, corresponding deflection elements 11a, 11b are provided, whereby a deflection element 11b is coupled with the laser head position or the carriage 14, so that the laser head 12 is always supplied with the laser beam 10.

It is also possible that the LIBS process 29 is started first, after which the user is prompted to place the material or the workpiece 7 below the material recognition area 33. After confirming, the laser head 12 is moved to the material recognition area 33, and the LIBS process 29 is performed.

Alternatively, the laser head 12 is first moved to the material recognition area 33, and then the user is prompted to place the material or the workpiece 7 below the material recognition area 33, so that the LIBS process 29 can be performed. It is also possible to use automatic material recognition, for example in the form of light barriers or contacts, to detect a material or workpiece 7 placed under the material recognition area 33, as this can release the execution of the LIBS process 29 or automatically start the LIBS process 29.

The main advantage of such a solution with a material recognition area 33, in which at least the spectrometer 30 is arranged, is that the laser head 12 or the focusing unit 12 is very agile, as no additional components that make the laser head 12 or the focusing unit 12 sluggish are attached to the laser head 12 or the focusing unit 12. Thus, a very high speed and precise processing of the workpiece 7 with the laser head 12 or the focusing unit 12 is achieved, while still being able to perform a LIBS process 29, in which the spectrometer 30 is required to record a plasma.

Preferably, the material recognition area 33 is arranged in the area of the processing room 8 that is not very frequently used for the usual processing of a workpiece 7. In FIG. 3, the workpiece 7 is usually placed in the corner area of the two rulers, i.e., top left or back, so that the material recognition area 33 in FIG. 3 is arranged on the top right or back side or that the material recognition area 33 is arranged on the front right side, according to FIG. 3a, or on the front left side, according to the dashed lines in FIG. 3a.

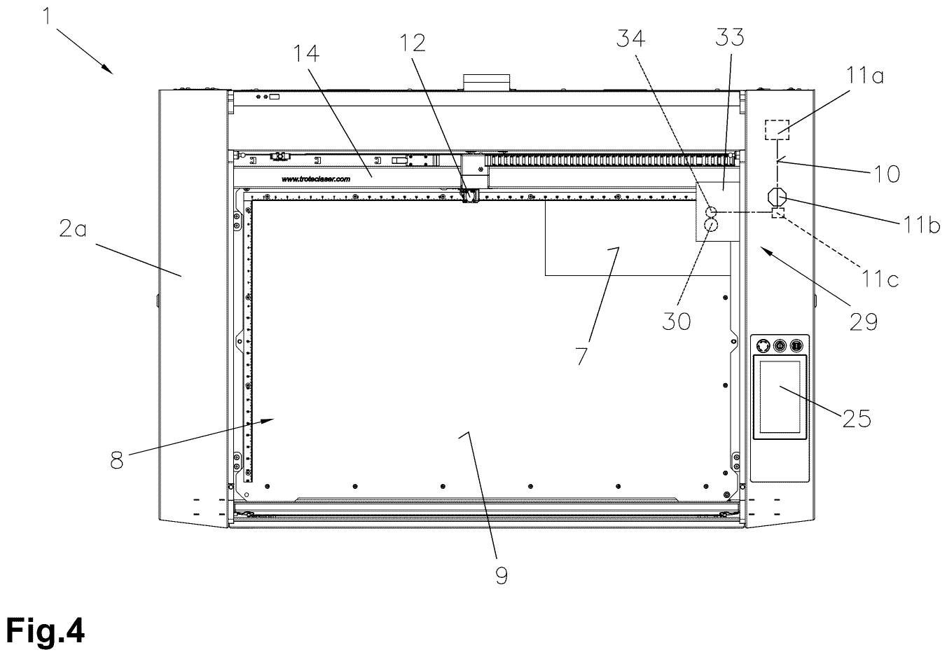

In FIG. 4, another embodiment is shown, in which a material recognition area 33 is again arranged in the processing room 8. In the material recognition area 33, the spectrometer 30 is again arranged, whereby an independent lens unit 34 for focusing the laser beam 10 is now provided, so that the lens head 12 or the focusing unit 12 is no longer needed for the LIBS process 29. In the material recognition area 33, the spectrometer 30 and the lens unit 34 are arranged, so that during the LIBS process 29, the laser head 12 or the focusing unit 12 can remain in the rest position outside the material recognition area 33.

To supply the lens unit 34 with a laser beam 10, the laser beam 10 is decoupled from the beam path for the laser head 12 or the focusing unit 12 and guided to the lens unit 34 via corresponding deflection elements 11c. In the shown embodiment in FIG. 4, the laser beam 10 is decoupled at the deflection element 11a, so that subsequently the laser beam 10 is redirected to the deflection element 11c and the laser beam 10 is guided from the deflection element 11c to the lens unit 34. A separate beam path to the lens unit 34 and to the laser head 12 or the focusing unit 12 is arranged, whereby preferably the same or a part of the beam path is used. It is also possible to use several deflection elements 11 or other optical elements for a laser beam 10 or light guides for transporting the laser beam 10.

Thus, the LIBS process 29 can now be easily performed by simply placing a workpiece 7 in or below the material recognition area 33. After starting the LIBS process 29, which can be done before or after placing the workpiece 7, the laser 5 or 6 is activated. The laser beam 10 is then redirected to the beam path for the lens unit 34, and the laser beam 10 is subsequently directed to the workpiece 7 via the lens unit 34, in which a lens for focusing the laser beam 10 on the workpiece 7 is preferably arranged. A plasma 31 of the material from the workpiece 7 is generated, after which the laser 6 or the laser beam 10 is preferably deactivated, and the spectrometer 30 is activated. The spectrometer 30 records the emitted light rays of the plasma 31. Subsequently, the recorded data can be analyzed by the spectrometer 30 or the control unit 13 or the external component 22, especially the laptop 22a or computer, preferably with a database or cloud, and the parameter “material” 28 can be suggested, displayed, or changed. The user can then use the determined material or parameter 28 and can remove the workpiece 7 from the material recognition area 33 and place it in the usual insertion position for further processing. Subsequently, a job 18 with a normal beam path, for example via the deflection element 11b, can be started. Of course, other positions in the processing room 8, as shown in FIG. 3a, are also possible for such a design of the material recognition area 33 with lens unit 34 and spectrometer 30.

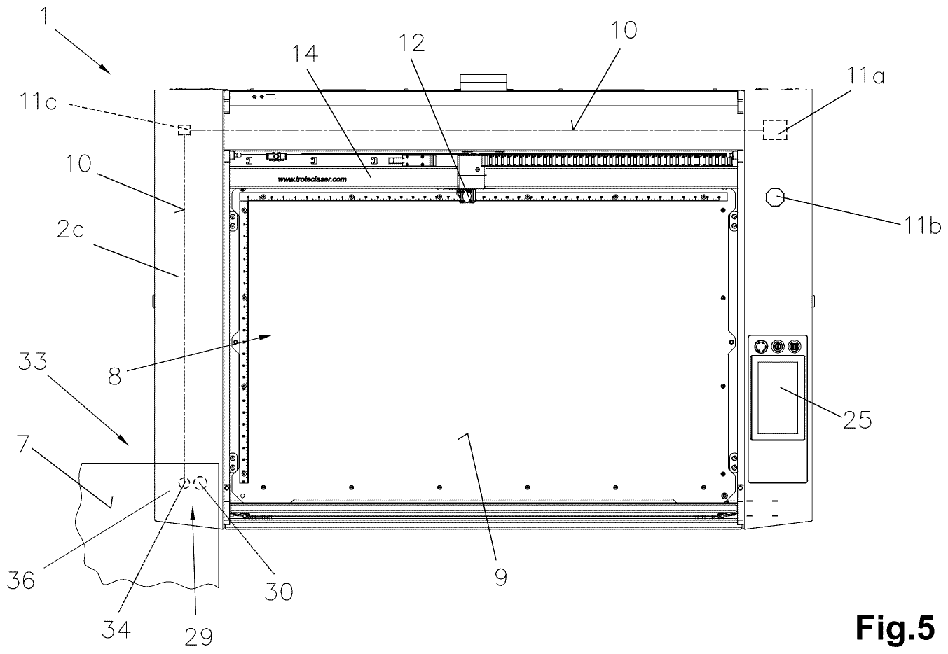

In FIGS. 5 and 6, another embodiment of an independent material recognition area 33 is shown, in which the material recognition area 33 is now arranged outside the processing room 8. In the housing 3 of the laser device 1, an opening or receptacle is provided, which is not connected to the processing room 8, in which a sample or the workpiece 7 can be inserted. In the housing 3 of the laser device 1, a slot 35, as shown in FIG. 6, or an extra lid 36 or receptacle 36 is arranged, so that a part of the workpiece 7 or a material sample of the workpiece 7 can be inserted from the outside. Preferably, a shelf for placing the workpiece 7 can be arranged for larger workpieces 7, or the workpiece 7 is held in position for the short LIBS process 29.

In the external material recognition area 33, the spectrometer 30 and the lens unit 34, as described in FIG. 4, are again arranged. By decoupling and redirecting the laser beam 10 via deflection elements 11 (11a, 11c), the lens unit 34 is supplied with a laser beam 10 during the activated LIBS process 29, so that the plasma 31 can subsequently be recorded by the spectrometer 30. It is possible that the slot 35 is arranged on the laser plotter 2a and the lid 15 or receptacle area is arranged on the galvo laser 2b.

It is advantageous if automatic material recognition is used, for example in the form of a light barrier, electrical contact, etc., to detect an inserted or inserted workpiece 7 or material. This can release or automatically start the LIBS process 29. By using an extra or independent material recognition area 33, it is advantageously possible to perform a LIBS process 29 or material recognition process in the material recognition area 33 in parallel during a processing process in the processing room 8. The recognized material is stored and/or used for the next processing process. It is also possible to have an external material recognition area 33 and an internal material recognition area 33, i.e., in the processing room 8, so that the user can choose which one to use.

In FIG. 6, the design of the galvo laser 2b with a separate laser 37, especially a so-called LIBS laser 37, is shown. For the LIBS process 29, a special laser 37 is activated instead of the laser 5 or 6 used for the usual processing. The laser beam 10 of the special laser 37 is coupled into the beam path for the LIBS process 29. For processing the workpiece 7, the laser 37 is subsequently deactivated, and the laser 5 or 6 is activated. Such a laser 37 for the LIBS process 29 can also be used in the other shown embodiments.

In FIG. 6, a schematic representation of the parameter “material” 28 in the application software on the external component 22, especially a laptop 22a, is shown. The material 28 “Wood” has just been recognized and set. Additionally, the parameter “material thickness” 38 of 2 mm and the parameter “laser power” 39 of 500 watts are shown. Further parameters for processing the workpiece 7 can be set.

With the integrated LIBS process 29, it is now possible to perform documentation and/or diagnosis of the processed workpieces 7 in addition to the normal setting process of a processing process, especially a job 18. If errors occur on the laser device 1, the documentation and/or diagnosis can be used to track whether only approved material was processed or whether unsuitable, unapproved material was inserted, which would void the warranty claim. Thus, misapplications that cause a fire, for example, can be easily detected.

Regardless, the LIBS process 29 can significantly increase the safety of operating such a laser device 1, as the material “PVC” must not be processed under any circumstances, as hydrochloric acid is formed. Thus, if the material “PVC” is inserted, the LIBS process 29 would recognize this and stop further processing.

Furthermore, the use of LIBS 29, especially according to the design in FIGS. 1, 2a, and 2b, allows safe operation with preferably automatic feeding and removal devices for the workpiece 7. Before each processing of a newly inserted workpiece 7, the laser head 12 or the focusing unit 12 automatically performs a LIBS process 29 and can thus recognize whether the correct material for the job 18 has been inserted. For different jobs 18 for different materials, the material of the inserted workpiece 7 can be recognized by the LIBS process 29, so that the corresponding job 18 is selected and executed.

Alternatively to the lasers 5 or 6 used for processing the workpieces 7, it is also possible to integrate or use a special laser 37 for the LIBS process 29 in the laser device 1. The laser beam of the special laser 37 is coupled into the beam path for the LIBS process 29. The laser beam can be coupled into the beam path of the laser head 12 or the focusing unit 12 or into the beam path for the material recognition area 33.

It is advantageous if the material recognition area 33 is darkened during the LIBS process 29. Flexible side walls or side panels close the open spaces. For example, in the external material recognition area 33, the lid 15 is closed after inserting the workpiece 7 or material 7, and any remaining open areas in the housing are closed with flexible side walls or side panels. This can also be done with the arrangement of the slot 35, where flexible side walls or side panels close the open areas to the workpiece 7 or material 7. Additionally, the internal material recognition area 33 can be designed so that after moving the laser head or focusing unit, the opening to the processing room 8 is covered to further reduce light entry into the otherwise darkened material recognition area 33 and thus advantageously influence the accuracy of the LIBS process 29. By darkening the area, especially the material recognition area 33, a significant improvement in the recognition of the inserted material during the LIBS process 29 is achieved. It is also advantageous if a process gas is used in the material recognition area 33 to influence the material reaction in the LIBS process 29. For example, inert gas can be supplied, which prevents the material or workpiece 7 from burning during irradiation with the laser 5, 6.

If the laser beam 10 is decoupled for the LIBS process 29, it is advantageous if the lens unit 34 considers the focus on the surface of the inserted workpiece 7 or material 7. For example, the lens of the lens unit 34 can be flexibly adjustable or movable, so that an optimal distance or focal point of the lens of the lens unit 34 to the workpiece/material 7 or the surface of the workpiece/material 7 is set for different workpiece thicknesses.

After a LIBS process 29 has been performed for a workpiece 7 to be processed, the parameter “material” 28, for example “Wood” or “Holz”, is recognized and displayed on the external component 22, especially on the laptop 22a, and/or on the input means 25 of the laser device 1. The user can then select the desired processing type, especially engraving or cutting, and further processing parameters, such as laser parameters, feed speed, extraction parameters, etc., can be set or adjusted. Thus, it is only necessary for the user to accept the recognized material 28 and set the processing type, so that the remaining parameters are then set. However, it is also possible that, for example, when selecting “cutting,” the user must set at least one additional parameter, especially the material thickness, before the remaining parameters are calculated or determined.

In principle, it should be noted that with a spectrometer 30 mounted on the laser head 12 or focusing unit 12, the spectrometer 30 can also be activated during the engraving or cutting process. For example, the spectrometer 30 can record the optical emission from areas where flame formation is suspected.

It is advantageous if the surface is cleaned before the actual LIBS process 29 is carried out. This means that, for example, after starting the LIBS process 29, the surface of the workpiece 7 or material is first cleaned by irradiation before the actual LIBS process 29 for generating and recording the plasma for evaluating the material is carried out. For this purpose, the surface is irradiated with the laser beam 10, so that any impurities or dirt are removed. Subsequently, the LIBS process 29 can be carried out.

For the sake of order, it should be noted that the disclosure is not limited to the illustrated embodiments but can also include further designs and constructions.

1. A method for determining at least one parameter of a laser device using LIBS (Laser Induced Breakdown Spectroscopy) for processing a workpiece, wherein at least one radiation source in a form of a laser is used in a housing of the laser device, wherein upon activation of the radiation source, a laser beam is directed to a focusing unit or laser head via deflection elements, wherein determining a parameter “material” for setting the laser device, a LIBS process is manually or automatically started by the laser device or an external component connected to the laser device whereupon the workpiece is processed in a known manner with a laser such that a small amount of material of the workpiece is vaporized, wherein the vaporized material is detected and evaluated via a spectrometer, whereupon the determined material is displayed to a user on the laser device or the external component and/or the determined material is set as a parameter “material” or compared with a set material.

2. The method according to claim 1, wherein, after the start of the LIBS process, a cleaning irradiation of a surface of the workpiece or material is first carried out before the LIBS process for material evaluation is executed.

3. The method according to claim 1, wherein the determined material is compared with stored materials, wherein for unsuitable materials an error message or indication appears on the laser device and/or the external component.

4. The method according to claim 1, wherein, in a processing area, a separate area in which the spectrometer is positioned is approached for executing the LIBS process, wherein the workpiece is first placed in this area, whereupon after the start of the LIBS process, the laser head is moved to a defined position for executing the LIBS process, wherein the vaporization of the workpiece is carried out via the laser head and the evaluation of the vaporized material is carried out via the spectrometer positioned in the area.

5. The method according to claim 1, wherein the laser beam is decoupled from a beam path for the laser head upon activation of the LIBS process.

6. The method according to claim 5, wherein the decoupled laser beam is guided into its own material recognition area inside or outside a processing area.

7. The method according to claim 5, wherein the decoupled laser beam is deflected in a material recognition area in a processing area.

8. The method according to claim 1, wherein in a material recognition area in a processing area and/or outside the processing area, at least one spectrometer for recording the vaporized material during the LIBS process is arranged and used.

9. The method according to claim 8, wherein the material recognition area outside the processing area is formed by a slot in the housing and/or a cover on the housing.

10. The method according to claim 1, wherein the LIBS process for determining the material accesses an external and/or internal database or cloud.

11. The method according to claim 1, wherein data of the LIBS process are collected for analysis, diagnosis, and/or documentation.

12. The method according to claim 1, wherein a separate laser source or laser is activated for the LIBS process, wherein its laser beam is coupled into a beam path for the laser head or a material recognition area.

13. A laser plotter for cutting, engraving, marking, and/or labeling a workpiece, which has a processing area for positioning the workpiece, at least one radiation source in a form of a laser with a corresponding deflection element and a control unit (13) for controlling a carriage driven by a belt drive with a focusing unit or laser head arranged thereon, wherein the focusing unit or laser head is equipped with a spectrometer for detecting a plasma generated by irradiation during an LIBS process.

14. A laser device in a form of a laser plotter or Galvo laser for cutting, engraving, marking, and/or labeling a workpiece, which has a processing area for positioning the workpiece, at least one radiation source in a form of a laser with a corresponding deflection element and a control unit for controlling a carriage driven by a belt drive with a focusing unit or laser head arranged thereon, wherein for executing an LIBS process, a laser beam is decoupled from a usual beam path, wherein the laser beam is deflected into a material recognition area, which is arranged in the processing area or outside the processing area.

15. The laser device according to claim 14, wherein at least one spectrometer for recording a plasma during the LIBS process is arranged in the material recognition area.

16. The laser device according to claim 14, wherein the laser device is designed to execute or perform a method for determining at least one parameter of the laser device.
